(19) United States
(12) Patent Application Publication
(10) Pub. No.: US 2009/0071803 A1
(43) Pub. Date: Mar. 19, 2009

(54) CONVEYOR CHAIN

(75) Inventors: LI-HUA ZHANG, Shenzhen (CN); KE ZHOU, Shenzhen (CN); JUN-ZHEN FENG, Shenzhen (CN); SHENG-QUAN ZHANG, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: SHENZHEN FUTAIHONG PRECISION INDUSTRY CO., LTD., ShenZhen City (CN); SUTECH TRADING LIMITED, Tortola (VG)

(21) Appl. No.: 11/964,839

(22) Filed: Dec. 27, 2007

(30) Foreign Application Priority Data
Sep. 14, 2007 (CN) 200710201704.5

(51) Int. Cl. B65G 17/06

(52) U.S. Cl. 198/853

(57) ABSTRACT

A convey chain (100) includes a plurality of link units (10) pivotly connected to one another. Each link unit includes a chain link (11), a connect link (12) and a carrier assembly (18). The connect link pivotly connects with the chain link, and includes a pair of side plates (121) and a transverse plate (123). The transverse plate transversely connects the pair of side plates. The carrier assembly is configured for carrying workpieces, and is upwardly mounted on the transverse plate.

### BACKGROUND

1. Technical field

The present invention relates to conveyor chains and, particularly, to a conveyor chain for conveying workpieces in a product line.

2. Description of the Related Art

A typical conveyor chain used in a product line and has a plurality of supporting arms horizontally outwardly extended for carrying or holding workpieces. One kind of conveyor chain only has supporting arms extending from one side thereof, and this kind of conveyor chain can be named as eccentric conveyor chain. Another kind of conveyor chain includes supporting arms extending symmetrically from two opposite sides thereof, and this kind of convey chain can be named as symmetrical conveyor chain.

In use, since workpieces supported by eccentric conveyor chain are all disposed on one side of the conveyor chain, the workpieces may pull the whole eccentric conveyor chain towards to said side and possibly turn over the conveyor chain. Symmetrical conveyor chain may reduce the risk of being turn over by the workpieces. However, when the quantities of workpieces supported on the two sides are not same, the symmetrical conveyor chain may be turned over.

Therefore, an improved conveyor chain is desired in order to overcome the above-described problems.

### SUMMARY

In one aspect, a conveyor chain is provided. The convey chain includes a plurality of link units pivotly connected to one another. Each link unit includes a chain link, a connect link and a carrier assembly. The connect link pivotly connects with the chain link, and includes a pair of side plates and a transverse plate. The transverse plate transversely connects with the pair of side plates. The carrier assembly is configured for carrying workpieces, and is upwardly mounted on the transverse plate.

Other advantages and novel features will become more apparent from the following detailed description when taken in conjunction with the accompanying drawings.

### BRIEF DESCRIPTION OF THE DRAWINGS

Many aspects of the present conveyer chain can be better understood with reference to the following drawings. The components in the drawings are not necessarily drawn to scale, the emphasis instead being placed upon clearly illustrating the principles of the conveyor chain. Moreover, in the drawings, like reference numerals designate corresponding parts throughout the several views.

FIG. 1 shows a conveyor chain formed by individual link units according to a present embodiment.

FIG. 2 shows a schematic, perspective view of the link unit of FIG. 1 in an assembled condition.

FIG. 3 shows a disassembled view of the link unit of FIG. 2.

### DETAILED DESCRIPTION OF THE PREFERRED EMBODIMENT

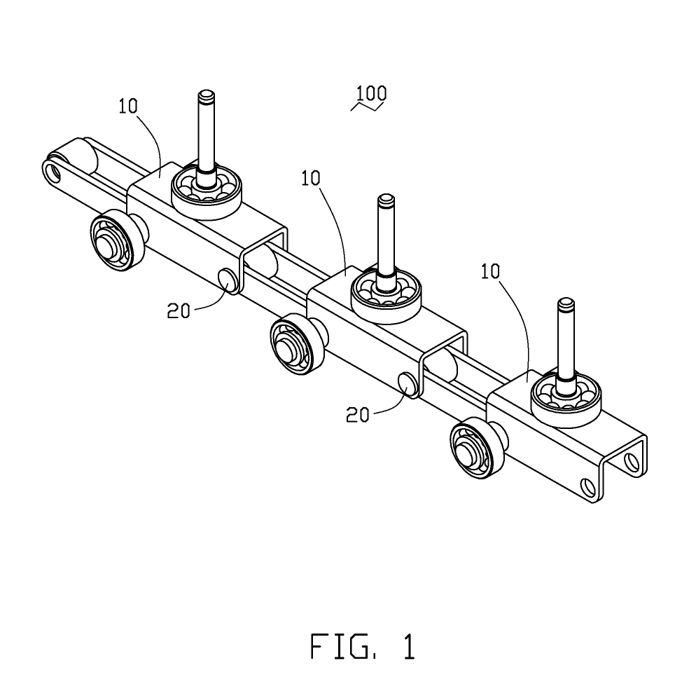

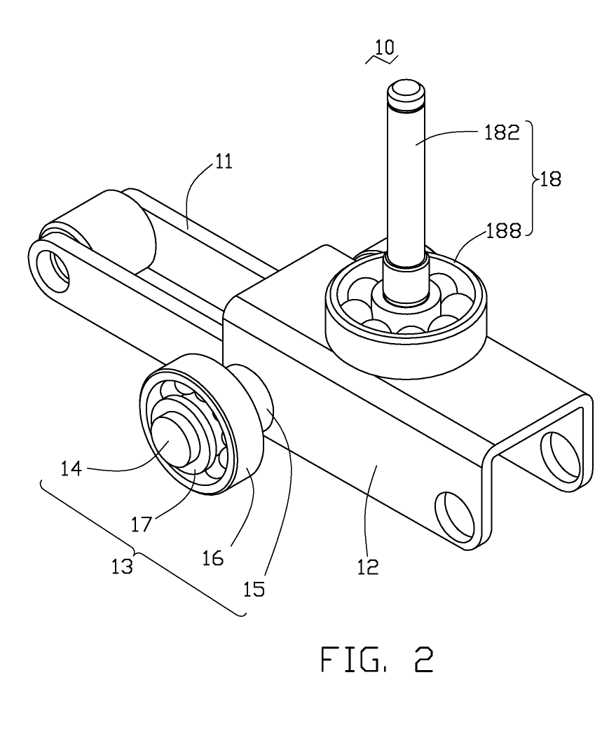

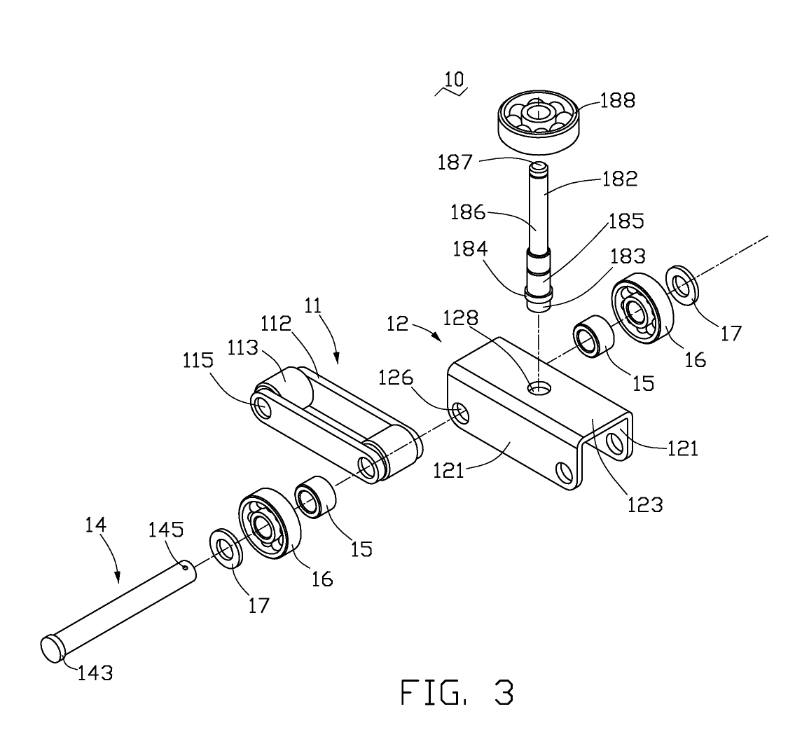

Referring now to the drawings in detail, FIG. 1 shows a conveyor chain 100 formed by a plurality of individual link units 10, according to a present embodiment. The link units 10 are connected to each other via rivets 20. Also referring to FIGS. 2 and 3, each link unit 10 includes a chain link 11, a connect link 12, a transmission assembly 13, and a carrier assembly 18.

The chain link 11 includes a pair of link plates 112 and a pair of rollers 113. The two link plates 112 are oppositely disposed to each other, and each link plate 112 has two holes 115 defined in two opposite ends thereof. The rollers 113 are hollow, and disposed between two corresponding ends of the two link plates 112. The roller 113 aligns with the holes 115 defined in the corresponding ends of the link plates 112. The roller 113 can rotate with respect to the link plates 112.

The connect link 12 can preferably be a U shaped plate, and includes a pair of side plates 121 and a transverse plate 123 transversely connecting with the two plates 112. The pair of side plates 121 is connected to two opposite sides of the transverse plate 123. Each side plate 121 has a pair of pores 126 defined in two opposite ends thereof. The pores 126 align with each other in the corresponding ends of side plate 121. The transverse plate 123 has an aperture 128 defined in a middle portion thereof. The link plates 112 of the chain link 11 is disposed between the pair of side plates 121, along with the holes 115 of the link plates 112, the roller 113 and the pores 126 aligning with each other.

The transmission assembly 13 is configured for pivotly connecting the chain link 11 to an adjacent connect link 12, and for transmitting power from a driving device (not shown) to drive the conveyor chain move 100. The transmission assembly 13 includes a shaft 14, two bushings 15, two bearings 16, and two washers 17. The shaft 14 can advantageously be a longitudinal cylinder, and includes a cap 143 disposed at a distal end, and a pin hole 145 defined in an opposite distal end thereof. The pin hole 145 is radially defined through the shaft 14, and is configured for engaging with a fixing member such as a pin. The bushings 15 can be rotatably mounted on the shaft 14. The bearings 16 can preferably be a roller bearing, and can be rotatably mounted on the shaft 14. The washers 17 also can be rotatably mounted on the shaft 14.

The carrier assembly 18 is configured for carrying/supporting/holding workpieces thereon, and includes a pole 182, and a bearing 188. The pole 182 can advantageously be a longitudinal cylindrical shaft, and defines a positioning end 183, a flange 184, a mounting portion 185, a main body 186, and a supporting end 187. The positioning end 183 is configured for engaging/mating with the aperture 128 of the transverse plate 123 of the connect link 12, thereby mounting the carrier assembly 18 to the connect link 12. The flange 184 is disposed between the positioning end 183 and the mounting portion 185, and has a diameter larger than that of the positioning end 183 and the mounting portion 185. The mounting portion 185 is configured for mating with the bearing 188. The main body 186 is disposed between the mounting portion 185 and the supporting end 187. The supporting end 187 is configured for carrying/supporting/holding workpieces thereon. The bearing 188 can preferably be a roller bearing, and can be rotatably mounted on the mounting portion 185 of the pole 182.

In assembly of the link unit 10, firstly, one end of the chain link 11 is placed between the pair of side plates 121 of the connect link 12, with the holes 115, the roller 113 of the chain link 11, and the pores 126 of the connect link 12 aligning with each other. Then, the distal end within the pin hole 145 of the shaft 14 is sequentially penetrated through a washer 17, a bearing 16, a bushing 15, the pore 126 of one side plate 121, the hole 115 of one link plate 112, the roller 113, the hole 115 of another link plate 112, the pore of another side plate 121, another bushing 15, another bearing 16, and finally penetrates and extends out of another washer 17. After that, the pin hole of the shaft 14 is engaged with a fixing member to hold the connection of the chain link 11, the connect link 12, and the transmission assembly 13. Then, the carrier assembly 18 is mounted to the connect link 12. The positioning end 183 engages with (e.g., being interference fitted in, or threadly connecting to) the aperture 128 of the transverse plate 123. The flange 184 abuts against the transverse plate 123. The bearing 188 is rotatably mounted on the mounting portion 185 of the pole 182.

The conveyor chain 100 further includes the rivets 20 for pivotly connecting one link unit 10 to another. In assembly, each rivet 20 connects two adjacent link units 10 by pivotly fastening the chain link 11 of one link unit 10 with the connect link 12 of another link unit 10.

It is to be understood that the shaft 14 of the transmission assembly 13 can instead be replaced by a rivet 20, and the other parts of the transmission assembly 13 can be mounted on the rivet 20. In addition, the other parts of the transmission assembly 13 can be omitted.

Furthermore, the chain link 11 can additionally include a transverse plate transversely connecting the pair of link plates 112, and a carrier assembly 18 can correspondingly be mounted to the additional transverse plate. Thus, the conveyor chain 100 can convey more workpieces at one time.

It is advantageous that the carrier assembly is extended upwardly from the chain links. When workpieces are carried by the carrier assemblies and transmitted by the conveyor chain, the workpieces are disposed above the convey chain. Therefore, the conveyor chain could keep balance in conveying process.

It is to be understood, however, that even though numerous characteristics and advantages of the present invention have been set forth in the foregoing description, together with details of the structure and function of the present invention, the disclosure is illustrative only, and changes may be made in detail, especially in matters of shape, size, and arrangement of parts within the principles of present invention to the full extent indicated by the broad general meaning of the terms in which the appended claims are expressed.

1. A conveyor chain comprises a plurality of link units pivotly connected to one another via rivets, each link unit comprising:
a chain link;
a connect link pivotly connecting with the chain link, and the connect link comprising a pair of side plates, and a transverse plate connecting the pair of side plates, the transverse plate defining an aperture defined in a middle portion thereof; and
a carrier assembly configured for carrying workpieces, and comprising a pole upwardly mounted on the transverse plate by engagement between one distal end of the pole and the aperture of the transverse plate.

2. The conveyor chain as claimed in claim 1, wherein the distal end of the pole is interference fitted or threadly connecting within the aperture, the opposite distal end of the pole is configured for carrying workpieces.

3. The conveyor chain as claimed in claim 2, wherein the carrier assembly further comprises a bearing, and the pole has a mounting portion for mating with the bearing.

4. The conveyor chain as claimed in claim 2, wherein the pair of plates connects with two opposite sides of the transverse plate, and each side plate has two pore respectively defined in two opposite ends thereof.

5. The conveyor chain as claimed in claim 4, wherein the chain link comprises a pair of link plates and two rollers, and each link plate has two hole respectively defined in two opposite ends thereof, the rollers respectively are rotatably disposed between two corresponding ends of the link plates and align with the holes in the corresponding ends.

6. The conveyor chain as claimed in claim 1, wherein each link unit further comprises a rivet pivotly connecting the chain link with the connect link.

7. The conveyor chain as claimed in claim 1, further comprising a transmission assembly for transmitting power from a driving device to drive the conveyor chain to move.

8. The conveyor chain as claimed in claim 7, wherein the transmission assembly comprises a pair of bearings symmetrically mounted on two opposite ends of the rivet, outside the link unit.

9. The conveyor chain as claimed in claim 8, wherein the transmission assembly further comprises a pair of bushings mounted on the rivet, and respectively disposed between the link units and the corresponding bearings.

10. The conveyor chain as claimed in claim 8, wherein the transmission assembly further comprises a pair of washers mounted on the rivet, and the washers are respectively disposed between the end of the rivet and the corresponding bearings.
